(19) United States
(12) Patent Application Publication
(10) Pub. No.: US 2007/0130526 A1
(43) Pub. Date: Jun. 7, 2007

(54) Storing and recalling groups of electronic mail addresses on user interfaces of multifunction devices

(75) Inventors: Julia Allwright, London (GB); Andy K. Balm, St. Albans (GB)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/295,295

(22) Filed: Dec. 6, 2005

(51) Int. Cl. G06F 17/00

(52) U.S. Cl. 715/752; 715/739

(57) ABSTRACT

A method for utilizing a graphical user interface for storing and recalling groups of electronic mail addresses to assist a user with document distribution from a scanning device provides functionality options on the user interface for scan to electronic mail capability. An electronic mail options menu displays electronic mail operation options, including electronic mail groups management, which enable a user to select an existing electronic mail group, view or edit an electronic mail group, and create a new electronic mail group.

### BACKGROUND AND SUMMARY

This disclosure relates generally to the distribution of documents from a scanning device and more particularly to a graphical user interface system and method for creating, storing, recalling, and editing groups of electronic mail addresses to assist a user with document distribution from the scanning device.

Optical scanning devices connected to a computer network provide the capability for images to be scanned into a computer system for modification and use by users whose computing devices are connected to the network. Distribution of the scanned images is accomplished through the use of electronic mail systems residing on the network and the presence of scan to electronic mail capability residing on the scanning device. Generally, scanning devices equipped with scan to electronic mail capability permit the user to either select recipients' electronic mail addresses from a local address book or type in the external electronic mail address through a graphical user interface. The document is then scanned and distributed through the network to the specified recipients.

However, there is no existing method for saving electronic mail addresses as a distribution list, for use when distributing documents to the same addresses on a repeated basis. Currently the user must select or type in the electronic mail addresses for each distribution session, which is time consuming and labor intensive. Therefore, what is needed is a method that allows a user of a scanning device to create, save, and use distribution lists to transmit scanned images from the device to multiple recipients. For the reasons stated above, and for other reasons stated below which will become apparent to those skilled in the art upon reading and understanding the present specification, there is a need in the art for a method of allowing a user of a scanning device equipped with scan to electronic mail capability to create and apply distribution lists from the graphical user interface of the scanning device.

All U.S. patents and published U.S. patent applications cited herein are fully incorporated by reference. The following patents or publications are noted:

U.S. Pat. No. 6,208,436 to Cunningham (“Use of a Header Page to Provide Scan Control Information for a Scan”) describes a header page for an optically scanned document. The header page is scanned and scan control information is extracted. The remaining pages of the document are then scanned into an image file. Upon completion of the scan, the image file is sent to a destination specified by the scan control information.

U.S. Pat. No. 6,459,499 to Tomat (“Push Technology for Network Scanner”) describes a system for scanning a document and sending a corresponding image file to a remote recipient using a software autosend utility that accesses predefined profiles of potential recipients. The predefined profiles include transport protocols and image scanning characteristics for the recipients. Based on the profile corresponding to the identity of the remote recipient, image scanning characteristics and a transport protocol for the resulting image data are both determined. The document is scanned in accordance with the determined image scanning characteristics, and a temporary image file containing image data for the scanned document is stored. The temporary image file is then sent to the remote recipient using the determined transport protocol.

U.S. Pat. No. 6,684,368 to Hull et al. (“Method for Specifying Delivery Information for Electronic Documents”) teaches a graphical user interface that presents document destinations in terms of recipient objects familiar to the user. The graphical user interface displays a plurality of potential recipients to a user. Responsive to input from the user, the method can select at least one potential recipient from the plurality of potential recipients to form a plurality of selected recipients. A scanning operation is then performed on a document to form an electronic copy of the document, which is transmitted to the selected recipients.

The disclosed embodiments provide examples of improved solutions to the problems noted in the above Background discussion and the art cited therein.

There is shown in these examples an improved method for utilizing a graphical user interface for storing and recalling groups of electronic mail addresses to assist a user with document distribution from a scanning device. The method provides functionality options on the user interface for scan to electronic mail capability. An electronic mail options menu displays electronic mail operation options, including electronic mail groups management, which enable a user to select an existing electronic mail group, view or edit an electronic mail group, and create a new electronic mail group.

In another embodiment there is provided a scanning device utilizing a graphical user interface to assist a user with document distribution from the scanning device. The graphical user interface causes the scanning device to perform method steps for storing and recalling groups of electronic mail addresses. The method provides functionality options on the user interface for scan to electronic mail capability. An electronic mail options menu displays electronic mail operation options, including electronic mail groups management, which enable a user to select an existing electronic mail group, view or edit an electronic mail group, and create a new electronic mail group.

In yet another embodiment, there is disclosed a graphical user interface for storing and recalling groups of electronic mail addresses to assist a user with document distribution from a scanning device. The graphical user interface includes functionality options on the user interface of the scanning device, with the functionality options including scan to electronic mail capability. An electronic mail options menu displays electronic mail operation options, including electronic mail groups management, which enable a user to select an existing electronic mail group, view or edit an electronic mail group, and create a new electronic mail group.

### BRIEF DESCRIPTION OF THE DRAWINGS

The foregoing and other features of the embodiments described herein will be apparent and easily understood from a further reading of the specification, claims and by reference to the accompanying drawings in which:

FIG. 1 is a block diagram of a system capable of storing and recalling groups of electronic mail addresses on a user interface;

FIG. 2 is a flow chart illustrating a method for storing and recalling groups of electronic mail addresses on a user interface;

FIG. 3 is a flow chart illustrating an alternate embodiment of a method for storing and recalling groups of electronic mail addresses on a user interface;

FIG. 4 is a flow chart illustrating further details of the embodiment of FIG. 3 of a method for storing and recalling groups of electronic mail addresses on a user interface;

FIG. 5 illustrates an example embodiment of an electronic mail address distribution control screen in accordance with the method for storing and recalling groups of electronic mail addresses on user interface;

FIG. 6 illustrates an example embodiment of an electronic mail address editing screen in accordance with the method for storing and recalling groups of electronic mail addresses on user interface; and

FIG. 7 illustrates and example embodiment of a passcode protect screen in accordance with the method for storing and recalling groups of electronic mail addresses on user interface.

### DETAILED DESCRIPTION

In the following detailed description, reference is made to the accompanying drawings, which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the disclosure. The following detailed description is, therefore, not to be taken in a limiting sense.

The method and system described herein provides the capability for creating, storing, and selecting a group of electronic mail addresses as a distribution list through the user interface of a scanning device. While some scanning devices offer a scan to electronic mail service, the user is limited to selecting electronic mail addresses from a local address book or keying in an external electronic mail address for each scanning session. The scanned image is then sent to the specified electronic mail addresses. Utilizing the method and system described herein, electronic mail addresses may be created, saved as a distribution list or alias, given a title, accessed for the transmission of scanned images, and password protected to prevent unauthorized use or spamming. The feature is accessible via a local user interface.

Various computing environments may incorporate capabilities for supporting an electronic mail network on which scanning devices reside. The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

The method and system may also be practiced in distributed computing environments where tasks are performed by remote processing devices that are linked through a communication network. In a distributed computing environment, program modules may be located in both local and remote memory storage devices.

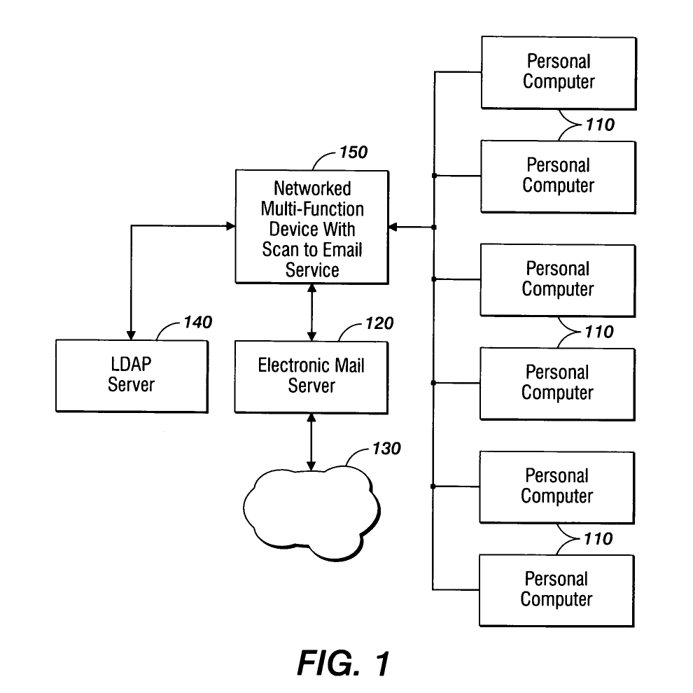

Referring to FIG. 1, the schematic diagram illustrates an example embodiment of a system for storing and recalling groups of electronic mail addresses on user interfaces. A multifunction device having a scan to electronic mail service 150 resides on a computer network including a plurality of computers 110 having email software incorporated into each of the computers for sending and receiving email messages through the communication network having an internet gateway 130. Electronic mail server 120 is a typical electronic mail server that receives and routes email from a set of users through network 130. It uses standard email protocols and network connections (such as SMTP (Simple Mail Transfer Protocol) over TCP/IP (Transmission Control Protocol/Internet Protocol)) to perform its service. LDAP (Lightweight Directory Access Protocol) server 140 provides access to a company-wide electronic mail address book as well as additional functionality.

The computers 110 typically have a processor, random-access memory, read-only memory, and one or more storage devices, such as a hard drive, CD-ROM, DVD, diskette, etc., as well as electronic mail capability. The processor is coupled to an output device, such as a display device, input devices, such as a keyboard, mouse, or pointer, and communication circuitry. The output device, for example a monitor, displays information for viewing by a user of computer 110 and the input device is used to control a screen pointer provided by the graphical user interface of the operating system.

As shown in FIG. 1, the computers 110 are coupled together and communicate via the network 130. In one embodiment, computer 110 includes a modem and corresponding communication drivers to connect to the Internet via what is known in the art as a “dial-up connection”. In another embodiment, the computers 110 are coupled together in only a local-area network (LAN). In yet another embodiment, the computers 110 include an Ethernet or similar hardware card to connect to the local-area network that itself is connected to the Internet via what is known in the art as a “direct connection”. In further embodiments, the computer 110 may be connected to the Internet using a cable modem or satellite Internet connectivity.

The system and method herein are not limited to a particular type of network system to which the computers 110 are connected. Typical network interfaces include general-purpose systems such as POTS (plain-old telephone systems) and ISDN (Integrated Services Digital Network), as well as special-purpose systems such as a LAN (local-area network) or a WAN (wide-area network). Such networking environments are commonplace in offices, enterprise-wide computer networks, intranets and the Internet. Those skilled in the art will appreciate that the principles of the system and method described herein can be applied to virtually any network system without departing from the scope of the claims and specification.

Multifunction device 150 may be any device capable of scanning image material and is equipped with a scan to electronic mail capability, which permits users of the device to select electronic mail addresses from a local address book or key in electronic mail addresses and transmit scanned images to the designated recipients. The scanned image may be in various formats, for example, PDF (portable document format), TIFF (tag image file format), JPEG (joint photographics experts group format), GIF (graphics interchange format), or BMP (BitMaP). In addition to scanning and transmitting the scanned image via electronic mail, multifunction device 150 may also include functionality for printing, copying, or transmitting facsimile images. Operation of multifunction device 150 is controlled from a user interface, which enables a user to select the function to be performed as well as enter information required by the device to perform an operation. Typically buttons or a keypad are utilized to enter information and select functionality, but a touch screen or any other means known in the art may be utilized. Multifunction device 150 communicates with LDAP server 140 as well as electronic mail server 120 and computers 110. The scan to email capability of the user interface also permits the user to amend the title of an electronic message and to compose a message to be transmitted with the scanned image.

Electronic mail server 120 receives the scanned image with electronic mail transmission instructions from multifunction device 150 and forwards the messages to internet gateway 130, which forwards it to the specified recipients.

The particular methods performed by the system for storing and recalling groups of addresses on a user interface comprise steps which are described below with reference to a series of flow charts. The flow charts illustrate an embodiment in which the methods constitute computer programs made up of computer-executable instructions. Describing the methods by reference to a flowchart enables one skilled in the art to develop software programs including such instructions to carry out the methods on computing systems. The language used to write such programs can be procedural, such as Fortran, or object based, such as C++. One skilled in the art will realize that variations or combinations of these steps can be made without departing from the scope of the disclosure herein.

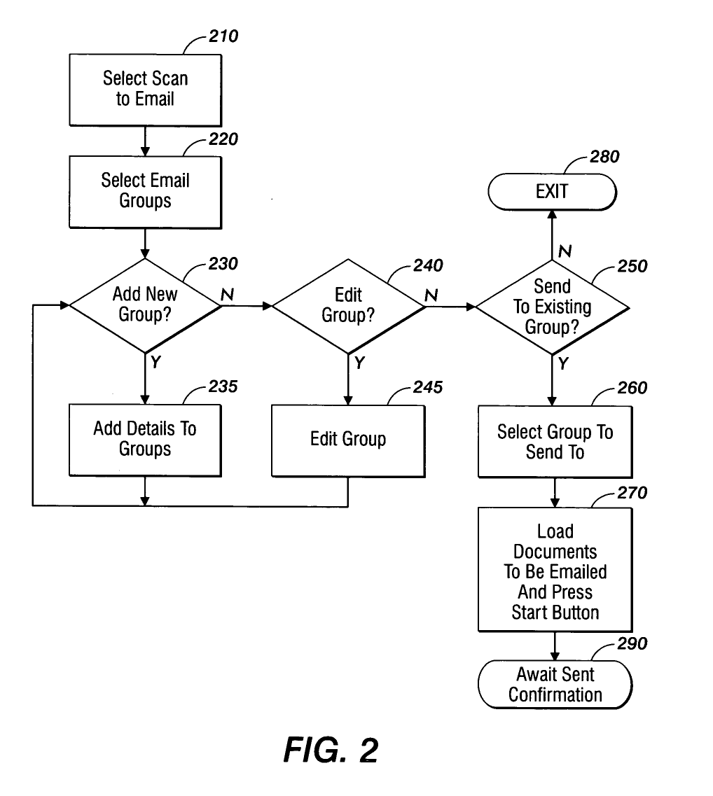

Turning now to FIG. 2, there is illustrated one embodiment of the method for storing and recalling groups of addresses on a user interface. The user of a multifunction device selects scan to email functionality on the user interface of the device, which may be accomplished through a touch pad, touch screen, buttons, selection of an icon, or a keypad at 210. An electronic mail group is selected at 220 from a menu on the user interface and an email groups screen is presented. The user may then select a group, view or edit a group, or create a new group of electronic mail addresses.

If a user decides to add a new group of electronic mail addresses at 230, the user enters the details associated with the new group, for example a group title, and the method returns to the email groups screen. If a user elects to edit or view an existing group at 240, the group is selected and edited at 245, after which the method returns to the email groups screen. When the user desires to send a scanned image to an existing group at 250, the group is selected from the email groups screen at 260, the image material is loaded on the multifunction device and scanning is initiated at 270. At the completion of scanning, the scanned image material is transmitted and the multifunction device pauses for confirmation of transmission from the electronic mail server. If a user decides not to transmit a scanned image to an existing group, add a new group, or view or edit an existing group, the method is exited at 280. While the method has been described with reference to a user interface having buttons, a touch screen, or icons to make selections and perform operations, it will be appreciated by one skilled in the art that the method may be practiced by a series of screen prompts through the user interface, which is fully contemplated by the specification and scope of the claims herein.

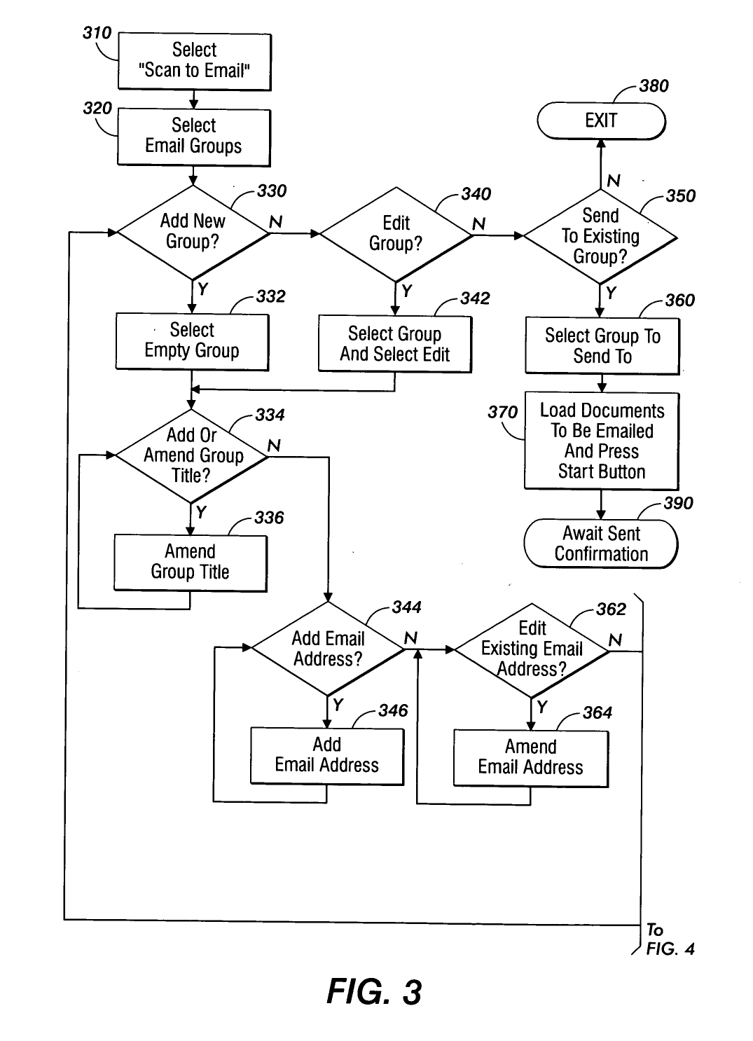

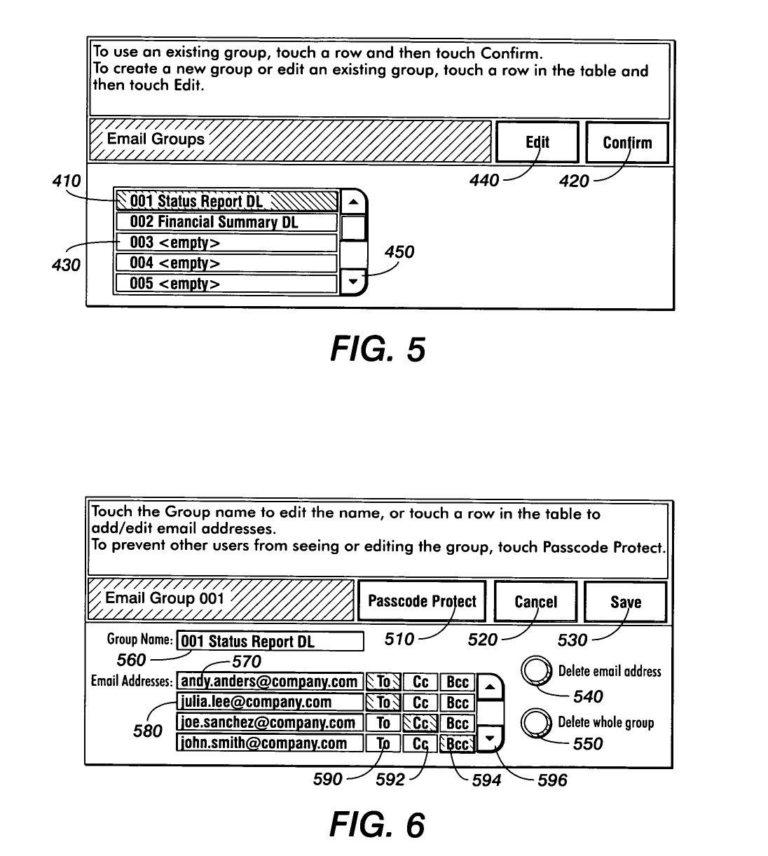

Turning now to FIGS. 3-6, there is illustrated another embodiment of the method for storing and recalling groups of addresses on a user interface. In this embodiment, the user of a multifunction device selects scan to email functionality on the user interface of the device, which may be accomplished through a touch pad, touch screen, buttons, selection of an icon, or a keypad at 310. Electronic mail group is selected at 320 from a menu on the user interface and an email groups screen is presented. One embodiment of an email groups screen appearing on the user interface of the multifunction device is illustrated in FIG. 5. From such a screen the user may select a group, view or edit a group, or create a new group of electronic mail addresses. To select an existing group of email addresses at 350, the user selects the name of one of the groups displayed on the email groups screen, for example 410, by pressing the row on the screen and then pressing confirm button 420. If more entries are available than are shown on the screen, scroll bar 450 permits the user to scroll among possible entries. The user may then load the image material on the scanner at 370 and activate the scanner, which scans the image material and transmits it to an electronic mail server. After transmission, the scanner pauses for confirmation at 390.

If a user desires to create a new electronic mail address group at 330, the user may select an empty group at 332 (illustrated in FIG. 5 at 430) and then touch the edit button 440. The user interface then displays an edit email groups screen, from which group names and existing electronic mail addresses can be edited. One embodiment of such a screen is illustrated in FIG. 6. If an empty group has been selected at 332, the group name entry at 560 will read “empty”. The group title is entered at 334 by selecting item 560 in FIG. 6, keying in the group title at 336, and saving the title by pressing save button 530. To add electronic mail addresses for the members of the new group or distribution list at 344, the user selects an empty email address location by touching a blank address button, which opens an add email address screen at 346 on the user interface. Names may be searched and added from a company address book, or email addresses may be keyed into the screen and saved by pressing save button 530.

Alternatively, a user may desire to edit an existing email group or distribution list at 342. In this case the user may select an existing group, such as 410 in FIG. 5, and press edit button 440. The user interface then displays an edit email groups screen, from which group names and existing electronic mail addresses can be created or edited. One embodiment of such a screen is illustrated in FIG. 6. If an existing group has been selected at 342, the group name entry may be modified by touching the group name, keying in the changes to the group name entry and saving the revised title by pressing save button 530. To edit existing electronic mail addresses for the members of a group or distribution list at 362, the user presses a displayed email address, for example 570 or 580 in FIG. 6, enters the modifications at 364, and saves the changes.

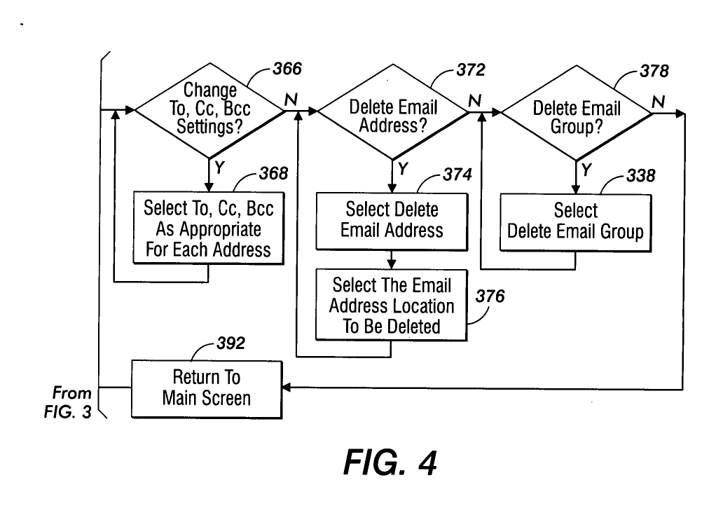

The user interface also provides for changing “To, Cc, and Bcc” settings at 366 (FIG. 4). The user may select the “To, Cc, or Bcc” buttons (590, 592, and 594 respectively) as appropriate for each address directly from the user interface at 368, with scroll bar 596 enabling the user to scroll up or down among the addresses. For each address the user selects the To, Cc, or Bcc button as appropriate. Electronic mail addresses may be deleted at 372 by selecting the delete email address button (button 540 in FIG. 6) at 374. The email address location to be deleted is selected at 376 by pressing the address to be deleted and a pop-up screen gives the user the opportunity to confirm the delete operation or cancel the operation. An entire distribution list may be deleted at 378 by pressing the delete email group key (button 550 in FIG. 6) at 338 and touching confirm on a confirmation pop-up screen.

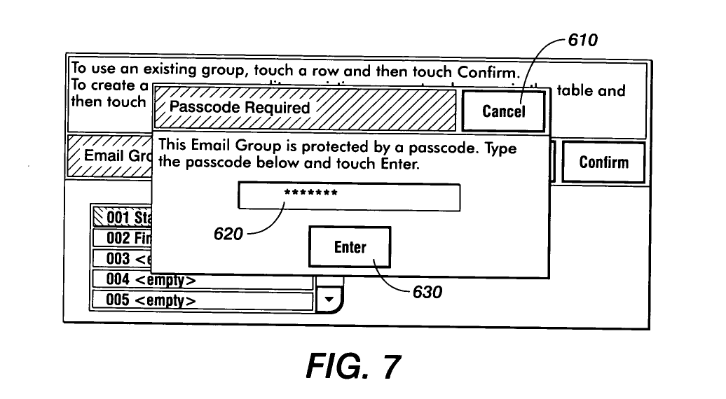

Electronic mail groups may be passcode protected to prevent other users from viewing or editing their details. To activate the passcode protect function, the user presses passcode protect button 510 in FIG. 6. If a group is passcode protected, a passcode protect screen, illustrated in FIG. 7 in an example embodiment, is displayed. The screen prompts the user to enter a passcode at passcode line 620 and press enter button 630. Until a valid passcode is entered, the details of the group cannot be displayed. The passcode screen may be exited by pressing cancel button 610.

While the present discussion has been illustrated and described with reference to specific embodiments, further modification and improvements will occur to those skilled in the art. Additionally, “code” as used herein, or “program” as used herein, is any plurality of binary values or any executable, interpreted or compiled code which can be used by a computer or execution device to perform a task. This code or program can be written in any one of several known computer languages. A “computer”, as used herein, can mean any device which stores, processes, routes, manipulates, or performs like operation on data. It is to be understood, therefore, that this disclosure is not limited to the particular forms illustrated and that it is intended in the appended claims to embrace all alternatives, modifications, and variations which do not depart from the spirit and scope of the embodiments described herein.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for utilizing a graphical user interface for storing and recalling groups of electronic mail addresses to assist a user with document distribution from a scanning device, the method comprising:
presenting functionality options on the user interface, said functionality options including scan to electronic mail capability;
providing means for selecting at least one said functionality option;
presenting a menu displaying electronic mail operation options, including electronic mail groups management;
presenting electronic mail groups management options on the user interface, wherein said electronic mail groups management options include at least one member selected from the group consisting of selecting an existing electronic mail group, viewing or editing an electronic mail group, and creating a new electronic mail group;
providing means for creating a new group of electronic mail addresses;
providing means for editing or viewing an existing group of electronic mail addresses; and
providing means for selecting an existing group of electronic mail addresses.

2. The method for utilizing a graphical user interface for storing and recalling groups of electronic mail addresses according to claim 1, further comprising providing means for passcode protection to prevent other users of the scanning device from viewing or editing the details of a passcode protected group.

3. The method for utilizing a graphical user interface for storing and recalling groups of electronic mail addresses according to claim 2, wherein said passcode protection comprises:
providing passcode protection selection means;
presenting a passcode protect screen; and
prompting a user to enter a passcode.

4. The method for utilizing a graphical user interface for storing and recalling groups of electronic mail addresses according to claim 1, wherein said means for selecting said functionality options include at least one member selected from the group consisting of touch pad, touch screen, buttons, icons, or a keypad.

5. The method for utilizing a graphical user interface for storing and recalling groups of electronic mail addresses according to claim 1, wherein means for selecting an existing group comprises:
presenting names of existing electronic mail groups with the electronic mail groups management options on the user interface; and
providing means for selecting at least one of said electronic mail groups.

6. The method for utilizing a graphical user interface for storing and recalling groups of electronic mail addresses according to claim 5, further comprising providing means for scrolling among available said existing electronic mail group names.

7. The method for utilizing a graphical user interface for storing and recalling groups of electronic mail addresses according to claim 1, wherein means for creating a new group of electronic mail addresses comprises:
presenting available slots for the entry of at least one new electronic mail group with the electronic mail groups management options on the user interface;
providing means for selecting at least one of said available electronic mail group slots;
providing means for selecting an editing function with the electronic mail groups management options on the user interface;
presenting electronic mail group editing options on the user interface;
providing means for selecting a title edit option from said electronic mail group editing options on the user interface, wherein said title edit option includes a slot for the entry of a title for said new electronic mail group;
providing means for entering said title of said new electronic mail group;
providing means for selecting an electronic mail address edit option from said electronic mail group editing options on the user interface, wherein said electronic mail address edit option includes at least one available slot for the entry of at least one electronic mail address; and
providing means for entering said at least one electronic mail address for each member of said new electronic mail group.

8. The method for utilizing a graphical user interface for storing and recalling groups of electronic mail addresses according to claim 7, wherein said electronic mail addresses for members of said new electronic mail group are either selected from an address book or entered on the user interface.

9. The method for utilizing a graphical user interface for storing and recalling groups of electronic mail addresses according to claim 7, wherein said means for selecting a title edit option and said means for selecting an electronic mail address edit option include a touch screen.

10. The method for utilizing a graphical user interface for storing and recalling groups of electronic mail addresses according to claim 1, wherein means for editing or viewing an existing group of electronic mail addresses comprises:
presenting names of existing electronic mail groups with the electronic mail groups management options on the user interface;
providing means for selecting at least one of said electronic mail groups;
providing means for selecting an editing function with the electronic mail groups management options on the user interface;
presenting electronic mail group editing options on the user interface;
providing means for selecting a title edit option from said electronic mail group editing options on the user interface, wherein said title edit option includes the name of an existing electronic mail group; and
providing means for editing said title of said selected existing electronic mail group.

11. The method for utilizing a graphical user interface for storing and recalling groups of electronic mail addresses according to claim 10, further comprising:
providing means for selecting an electronic mail address edit option from said electronic mail group editing options on the user interface, wherein said electronic mail address edit option includes at least one existing electronic mail address; and
providing means for editing said at least one electronic mail address.

12. The method for utilizing a graphical user interface for storing and recalling groups of electronic mail addresses according to claim 10, wherein said means for selecting a title edit option includes a touch screen.

13. The method for utilizing a graphical user interface for storing and recalling groups of electronic mail addresses according to claim 11, wherein said means for selecting an electronic mail address edit option includes a touch screen.

14. The method for utilizing a graphical user interface for storing and recalling groups of electronic mail addresses according to claim 1, further comprising providing the capability for changing To, Cc, and Bcc settings on said user interface.

15. The method for utilizing a graphical user interface for storing and recalling groups of electronic mail addresses according to claim 14, wherein providing the capability for changing “To, Cc, and Bcc” settings on said user interface comprises:
presenting electronic mail group editing options on the user interface;
providing means for selecting said “To, Cc, and Bcc” settings edit option from said electronic mail group editing options on the user interface, wherein said “To, Cc, and Bcc” settings are associated with at least one electronic mail address for at least one member of a selected electronic mail group;
providing means for selecting said at least one electronic mail address; and
providing means for selecting a “To, Cc, and Bcc” setting for said at least one electronic mail address.

16. The method for utilizing a graphical user interface for storing and recalling groups of electronic mail addresses according to claim 15, wherein said means for selecting said at least one electronic mail address comprises a scroll bar.

17. The method for utilizing a graphical user interface for storing and recalling groups of electronic mail addresses according to claim 15, wherein said means for selecting said “To, Cc, and Bcc” setting for said at least one electronic mail address comprises a touch screen.

18. The method for utilizing a graphical user interface for storing and recalling groups of electronic mail addresses according to claim 1, further comprising providing the capability for deleting at least one member selected from the group selected from existing electronic mail addresses and existing electronic mail groups.

19. The method for utilizing a graphical user interface for storing and recalling groups of electronic mail addresses according to claim 18, wherein deleting at least one existing electronic mail address from an electronic mail group comprises:
presenting electronic mail group editing options on the user interface, wherein said electronic mail group editing options include deleting an electronic mail address;
providing means for selecting said option for deleting an electronic mail address from said electronic mail group editing options on the user interface; and
providing means for selecting at least one electronic mail address to be deleted.

20. The method for utilizing a graphical user interface for storing and recalling groups of electronic mail addresses according to claim 18, wherein deleting at least one existing electronic mail group comprises:
presenting electronic mail group editing options on the user interface, wherein said electronic mail group editing options include deleting an electronic mail group;
providing means for selecting said option for deleting an electronic mail group from said electronic mail group editing options on the user interface; and
providing means for selecting at least one electronic mail group to be deleted.

21. A scanning device utilizing a graphical user interface to assist a user with document distribution from the scanning device, wherein the graphical user interface causes the scanning device to perform method steps for storing and recalling groups of electronic mail addresses, the method comprising:
presenting functionality options on the user interface, said functionality options including scan to electronic mail capability;
providing means for selecting at least one said functionality option;
presenting a menu displaying electronic mail operation options, including electronic mail groups management;
presenting electronic mail groups management options on the user interface, wherein said electronic mail groups management options include at least one member selected from the group consisting of selecting an existing electronic mail group, viewing or editing an electronic mail group, and creating a new electronic mail group;
providing means for creating a new group of electronic mail addresses;
providing means for editing or viewing an existing group of electronic mail addresses; and
providing means for selecting an existing group of electronic mail addresses.

22. A graphical user interface for storing and recalling groups of electronic mail addresses to assist a user with document distribution from a scanning device, the graphical user interface comprising:
functionality options on the user interface of the scanning device, wherein said functionality options include scan to electronic mail capability;
means for selecting at least one said functionality option;
menu displaying electronic mail operation options, including electronic mail groups management;
electronic mail groups management options on the user interface, wherein said electronic mail groups management options include at least one member selected from the group consisting of selecting an existing electronic mail group, viewing or editing an electronic mail group, and creating a new electronic mail group;
means for creating a new group of electronic mail addresses;
means for editing or viewing an existing group of electronic mail addresses; and
means for selecting an existing group of electronic mail addresses.
